(19) United States
(12) Patent Application Publication
(10) Pub. No.: US 2026/0290306 A1
(43) Pub. Date: Sep. 24, 2026

(54) GENERATING AUDIO USING NON-AUTOREGRESSIVE DECODING

(71) Applicant: Google LLC, Mountain View, CA (US)

(72) Inventors: Zalán Borsos, Zug (CH); Marco Tagliasacchi, Ruvigliana (CH)

(21) Appl. No.: 19/477,525

(22) PCT Filed: Apr. 29, 2024
(86) PCT No.: PCT/US2024/026811

§ 371 Date: Oct. 22, 2025

Related U.S. Application Data
(60) Provisional application No. 63/462,498, filed on Apr. 27, 2023.
(60) Provisional application No. 63/465,332, filed on May 10, 2023.

(51) Int. Cl. G10L 13/027

(52) U.S. Cl. CPC G10L 13/027

(57) ABSTRACT

Methods, systems, and apparatus, including computer programs encoded on computer storage media, for generating an output audio signal. In some implementations, the output audio signal can be generated by using a generative neural network in a number of iterations that is independent of the length of the output audio signal.

### CROSS-REFERENCE TO RELATED APPLICATION

This application claims priority to U.S. Provisional Application No. 63/462,498, filed on Apr. 27, 2023 and to U.S. Provisional Application No. 63/465,332, filed on May 10, 2023. The disclosure of the prior applications is considered part of and is incorporated by reference in the disclosure of this application.

### BACKGROUND

This specification relates to generating audio using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes an audio generation system implemented as computer programs on one or more computers in one or more locations that generates an output audio signal. In some implementations, the audio generation system can generate the output audio signal in a number of iterations that is independent of the length of the output audio signal.

According to one aspect there is provided a method performed by one or more computers, the method comprising: receiving a masked representation of an audio signal as a sequence of tokens, wherein the sequence of tokens comprises one or more masked tokens; processing the masked representation of the audio signal using a neural network, comprising: processing the masked representation of the audio signal using an embedding layer of the neural network to generate a sequence of embeddings that comprises a respective embedding of each token in the sequence of tokens; processing the sequence of embeddings using a pooling layer of the neural network to generate a sequence of pooled embeddings, wherein each pooled embedding in the sequence of pooled embeddings results from pooling a respective plurality of embeddings from the sequence of embeddings; processing the sequence of pooled embeddings using an attention block of the neural network to update the sequence of pooled embeddings, comprising applying one or more self-attention operations to the sequence of pooled embeddings; and processing the updated sequence of pooled embeddings to generate, for each of one or more positions in the sequence of tokens, a respective prediction characterizing a token that should occupy the position in the sequence of tokens.

In some implementations, the attention block is a convolution-augmented attention block that comprises one or more convolutional layers and one or more self-attention layers.

In some implementations, applying one or more self-attention operations to the sequence of pooled embeddings comprises applying one or more local self-attention operations to the sequence of pooled embeddings.

In some implementations, applying one or more local self-attention operations to the sequence of pooled embeddings comprises sequentially applying a plurality of local self-attention operations to the sequence of pooled embeddings.

In some implementations, receiving the representation of the audio signal as a sequence of tokens comprises receiving a sequence of acoustic tokens generated by a neural audio codec comprising a plurality of residual vector quantizers.

In some implementations, receiving the representation of the audio signal as a sequence of tokens comprises: receiving a sequence of semantic tokens generated by an intermediate layer of an auxiliary audio processing neural network.

In some implementations, receiving the sequence of semantic tokens comprises resampling the sequence of semantic tokens based on a sampling rate of the sequence of acoustic tokens.

In some implementations, processing the sequence of embeddings using the pooling layer to generate the sequence of pooled embeddings comprises: processing, by the pooling layer, the sequence of embeddings in accordance with a stride that is dependent on a total number of the residual vector quantizers.

In some implementations, a value of the stride is the same as the total number of the residual vector quantizers.

In some implementations, an output block of the neural network comprises multiple output heads and wherein processing the updated sequence of pooled embeddings to generate, for each of one or more positions in the sequence of tokens, a respective prediction characterizing the token that should occupy the position in the sequence of tokens comprises: processing the sequence of updated pooled embeddings by each output head independently and in parallel with other output heads to generate respective predictions characterizing a plurality of tokens at different positions in the sequence of tokens.

In some implementations, each output head is configured to: receive a respective pooled embedding from the updated sequence of pooled embeddings; and process the pooled embedding to generate a respective prediction for each position in a same frame of the sequence of tokens, wherein the output head generates the predictions for positions in the same frame in parallel.

In some implementations, the method further comprises selecting a plurality of positions in the sequence of tokens to be unmasked, wherein each position selected to be unmasked is occupied by a masked token; and determining, for each of the plurality of positions selected to be unmasked, a respective unmasked token to occupy the position based on a prediction generated by the neural network for the token that should occupy the position.

In some implementations, selecting a plurality of positions in the sequence of tokens to be unmasked comprises, for each position in the sequence of tokens that is occupied by a masked token: determining whether to select the position to be unmasked based on a confidence in a prediction generated by the neural network characterizing the token that should occupy the position in the sequence of tokens.

In some implementations, some or all of the positions in the sequence of tokens are associated with a respective residual vector quantizer in a sequence of residual vector quantizers; and selecting a plurality of positions in the sequence of tokens to be unmasked comprises, for each position in the sequence of tokens that is occupied by a masked token: determining whether to select the position to be unmasked based on the residual vector quantizer associated with the position.

In some implementations, selecting the plurality of positions in the sequence of tokens to be unmasked comprises: identifying a set of masked tokens that are eligible to be unmasked, comprising selecting each masked token that is associated with a particular residual vector quantizer for inclusion in the set of masked tokens that are eligible to be unmasked; and selecting a plurality of tokens from the set of masked tokens that are eligible to be unmasked as tokens that should be simultaneously unmasked.

In some implementations, all tokens associated with any residual vector quantizer that precedes the particular residual vector quantizer in the sequence of residual vector quantizers have already been unmasked; and all tokens associated with any residual vector quantizer that is after the particular residual vector quantizer in the sequence of residual vector quantizers has not yet been unmasked.

In some implementations, for each of the plurality of positions selected to be unmasked, the prediction generated by the neural network for the token that should occupy the position comprises a score distribution over a set of tokens.

In some implementations, for each of the plurality of positions selected to be unmasked, determining the unmasked token to occupy the position comprises: sampling a token from the score distribution over the set of tokens.

In some implementations, the method further comprises: determining, for each of one or more positions in the sequence of tokens that are occupied by masked tokens, a first difference between: (i) the token that should occupy the position, and (ii) the respective prediction characterizing the token that should occupy the position; and determining, based at least on first difference, an update to values of a set of parameters of the neural network.

In some implementations, the method further comprises: determining, for each of one or more positions in the sequence of tokens that are occupied by unmasked tokens, a second difference between: (i) the token that should occupy the position, and (ii) the respective prediction characterizing the token that should occupy the position; and determining, based on both the first and second differences, the update to values of the set of parameters of the neural network.

In some implementations, determining second difference comprises down-weighting the second difference relative to the first difference.

In some implementations, the method further comprises generating the masked representation of the audio signal as the sequence of tokens, comprising: determining a start time step within a plurality of time steps of the audio signal; and replacing tokens at a predetermined number of contiguous time steps that follow the start time step with masked tokens.

In some implementations, the method further comprises generating the masked representation of the audio signal as the sequence of tokens, comprising: obtaining a representation of the audio signal as a sequence of tokens generated by a sequence of residual vector quantization layers in a neural audio codec; selecting a target vector quantization layer; masking only tokens that are associated with the target vector quantization layer or vector quantization layers that are after the target vector quantization layer in the sequence of vector quantization layers.

In some implementations, the method further comprises generating an output audio signal based at least on the respective unmasked tokens.

According to another aspect there are provided one or more computer storage media storing instructions that when executed by one or more computers cause the one or more computer to implement the methods described herein.

According to another aspect there is provided a system comprising: one or more computers; and one or more storage devices storing instructions that, when executed by the one or more computers, cause the one or more computers to perform the respective operations of the methods described herein.

Particular embodiments of the subject matter described in this specification can be implemented so as to realize one or more of the following advantages.

This specification describes a system that uses a generative neural network to generate high-quality and semantically coherent audio. Compared with existing audio generation systems, the described system can generate audio that spans a longer length of time, has a wider variety of semantic representations, e.g., not only speech but also music, ambient sounds, sound events, and the like, or both. By relying on local attention, the complexity and inference cost of the model depends linearly, e.g., rather than quadratically (as in the case of self-attention), on the length of model input. Using the described system to generate audio of comparable time length to that generated by existing systems will thus result in reduced consumption of processor cycles, memory, and power.

Moreover, the system is configured to generate audio data by a non-autoregressive decoding procedure, in particular, by a parallel decoding procedure, where multiple tokens (implicitly representing audio data) are predicted jointly in a single forward pass, at higher quality while being significantly faster, e.g., in terms of wall clock time, as well as consuming reduced computing resources than what would otherwise be required by auto-regressively predicting audio tokens one after another. In some implementations, the audio generation system can generate an output audio signal in exactly a predetermined number of iterations time steps no matter the length of the output audio signal.

Advantageously, in some implementations where the generative neural network generates tokens that represent code vectors that could be generated by a hierarchy of multiple vector quantizers which will be further processed by a decoder neural network to generate the output audio, the parallel decoding configuration allows the system to reduce the computing resource consumption in generating the output audio by leveraging the hierarchical ordering of the multiple vector quantizers. For example, multiple tokens associated with the same vector quantizer can be generated in parallel.

In more detail, some conventional systems generate audio data autoregressively, e.g., by generating a sequence of audio samples one sample at a time starting from the first audio sample, where each audio sample is generated in a manner that is conditioned on the previously generated audio samples. However, generating high quality audio data can require generating very lengthy sequences of audio data samples, e.g., more than 40,000 audio data samples for one second of audio. Generating lengthy sequences of audio data samples autoregressively may be computationally inefficient and time consuming, e.g., as generating each new sample requires performing a new forward pass through the audio generation system.

The system described in this specification addresses these issues by enabling efficient generation of lengthy sequences of audio data by a parallel decoding procedure. In particular, the system can generate audio data by iteratively unmasking a sequence of tokens representing code vectors in the codebooks of a residual vector quantizer. The system can then process the sequence of tokens to generate a compressed representation of the audio signal, and then process that compressed representation by a decoder neural network to generate the full audio signal.

The sequence of tokens (i.e., that is iteratively unmasked by the system) is partitioned into “frames,” where each frame includes a respective token for each vector quantizer in a sequence of vector quantizers, e.g., of a residual vector quantizer (RVQ). The system can unmask the tokens in the sequence of tokens level by level, e.g., by first unmasking all the tokens associated with the first vector quantizer, then unmasking all the tokens associated with the second vector quantizer, then unmasking all the tokens associated with the third vector quantizer, and so forth. (The “level” of a token can refer to the position of the vector quantizer associated with the token in the sequence of vector quantizers). The system can unmask the tokens at a particular level by a parallel decoding procedure, e.g., where multiple tokens at the level at unmasked simultaneously. Unmasking the sequence of tokens level by level respects the conditional dependencies between levels of the RVQ hierarchy and exploits the conditional independence of tokens from “finer” (i.e., later) levels given all tokens from “coarser” (i.e., earlier) levels.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B show an example audio generation system.

FIG. 2 is an example illustration of operations performed by a generative neural network.

FIG. 3 is a flow diagram of an example process for processing a masked representation of an audio signal using a neural network.

FIGS. 4A-B show quantitative examples of the performance gains that can be achieved by audio generation system described in this specification.

Like reference numbers and designations in the various drawings indicate like elements.

### DETAILED DESCRIPTION

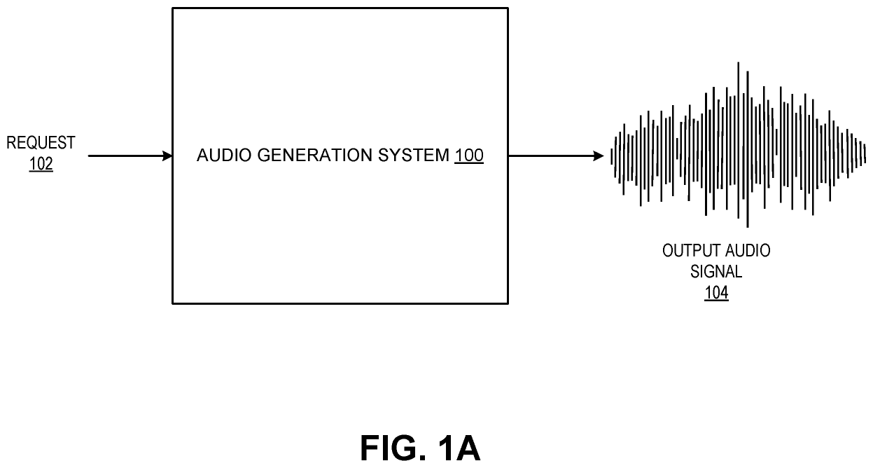

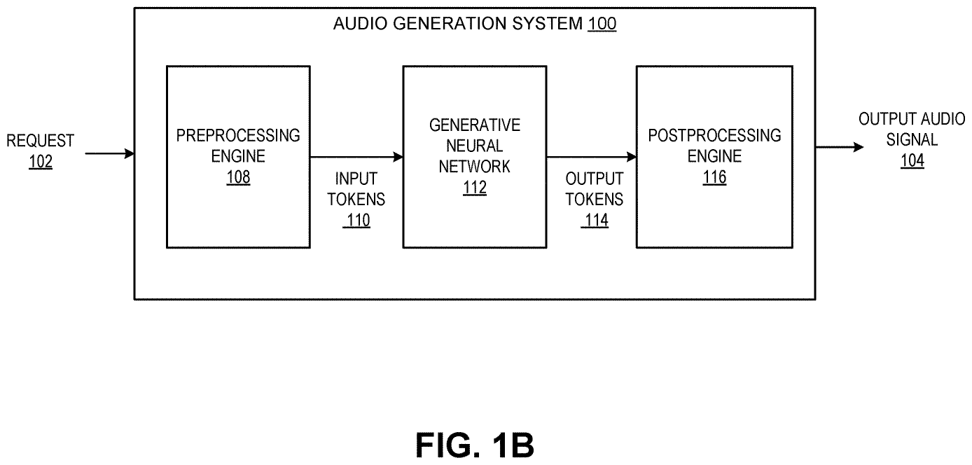

FIG. 1A is a block diagram of an example audio generation system 100. The audio generation system 100 is an example of a system implemented as computer programs on one or more computers in one or more locations in which the systems, components, and techniques described below are implemented.

The audio generation system 100 generates an output audio signal 104 given a request 102 to generate an audio signal. In some implementations, the request 102 can specify a context for the audio signal 104. In these implementations, the output audio signal 104 is conditioned on the context.

Generally, the output audio signal 104 is an output audio example that includes a sample of an audio wave at each of a sequence of output time steps that span a specified time window. For example, the output time steps can be arranged at regular intervals within the specified time window.

The audio sample at a given time step can be an amplitude value of the audio wave or an amplitude value that has been compressed, companded, or both. For example, the audio sample can be a raw amplitude value or a mu-law companded representation of the amplitude value.

The audio generation system 100 can be configured to perform any of a variety of tasks that require generating an audio signal as output.

For example, the output audio signal 104 can be a speech signal and the system can generate the speech signal unconditionally, e.g., resulting in a speech signal being generated that is drawn from a distribution represented by the training data set(s) on which the generative neural network(s) were trained. As another example, the output audio signal 104 can be a different type of audio signal, e.g., music, ambient sounds, sound events, and so on, and the system can generate the audio signal unconditionally, e.g., resulting in an audio signal being generated that is drawn from a distribution represented by the training data set(s) on which the generative neural network(s) were trained.

As another example, the audio generation system 100 can receive a context along with the request 102 to generate an audio signal and generate the output audio signal 104 conditioned on the received context.

For example, the output audio signal 104 can be a speech or other audio signal, i.e., so that the system generates the output audio signal 104 conditioned on a context that is an input audio signal.

For example, the context can include an audio input as an input audio signal. In some examples, the audio input can include words spoken by a particular speaker, and the output audio signal 104 can be a continuation of the words spoken by the particular speaker. In some examples, the audio input can include music, and the output audio signal 104 can be a continuation of the music in the audio input.

In some implementations, the output audio signal 104 that is generated can be a prediction of an audio signal that follows the input audio signal. For example, the context can be an input speech signal that is a question that is asked by one speaker and the output audio signal can be an output speech signal that is an answer to the question spoken by the same speaker or another speaker. As another example, the context can be an input speech signal that is a first portion of an utterance spoken by one speaker and the input audio signal can be an output speech signal that is a completion of the utterance spoken by the speaker or by another speaker or a response to the input utterance.

In some implementations, the input audio signal can include a melody, and the output audio signal 104 can be music that follows the melody. The system can generate an output audio signal 104 that is music that follows the melody.

As another example, the audio generation system 100 can perform sound separation on the input audio signal to generate the output audio signal 104. For example, the input audio signal can include both speech and music or other background noise and the output audio signal can represent only the speech. As another example, the input audio signal can include speech from multiple speakers (and optionally background noise) and the output audio signal 104 can include only the speech of one of the speakers. In some examples, the system can perform audio-conditional separation, i.e., when the input audio signal can include an extra audio input acoustically similar to one of the sources.

As another example, the audio generation system 100 can perform speech-to-speech translation, where the input speech and the output speech represent the same semantic content but spoken differently. For example, the input audio signal can include speech in one natural language and the output audio signal 104 can represent speech in a target, different natural language that is a translation of the input speech into the target language. As another example, the input audio signal can include speech spoken by a first speaker and the output audio signal 104 can represent the same semantic content as the input speech but spoken by a different speaker. As another example, the input audio signal can include a first speech segment and the output audio signal 104 can include a second, shorter speech segment that summarizes the semantic content of the first speech.

As another example, the context can include both audio data and text data. In this example, the output audio signal 104 can include speech that reflects the text data. In some implementations, the output audio signal 104 can include music that reflects the text data. In these implementations, the system generates an output audio signal 104 that reflects the text data.

For example, the audio generation system 100 can perform transcript conditioned speech enhancement, where the context is a text transcript and noisy audio corresponding to the text transcript and the output audio signal 104 is clean audio corresponding to the text transcript.

As another example, the audio generation system 100 can perform transcript-based audio in-filling, where the context is a text transcript and audio corresponding to a portion of the text transcript, and the output audio signal 104 corresponds to a different portion of the text transcript.

As another example, the audio generation system 100 can perform text-to-speech, where the context is a sequence of text, and the output audio signal 104 is a verbalization of the sequence of text. As a particular example of this, the audio generation system 100 can perform speaker-conditioned text-to-speech, where the context is a text transcript and audio of a speaker and the output audio signal 104 is a verbalization of the text transcript being spoken by the speaker.

As another example, the context can include both audio data and visual, e.g., image or video, data. In this example, the output audio signal 104 can include speech that describes the visual data or music that reflects the visual data.

For example, the audio generation system 100 can perform audio-video continuation, where the system receives a partial audio track with corresponding video, and the output audio signal 104 is a continuation of the partial audio track.

As another example, the audio generation system 100 can perform cross-modal in-filling, where the system receives video and an audio track corresponding to a portion of the video and the output audio signal 104 is an audio track corresponding to a different portion of the video.

As another example, the context input can include only visual data.

For example, the audio generation system 100 can perform image-conditioned audio generation, where the system receives an input image and generates an output audio signal 104 that describes the image.

As another example, the context input can include only text data.

For example, the audio generation system 100 can perform sound synthesis based on text descriptions, e.g., where the input is text that describes an audio signal and the output is an output audio signal 104 that is characterized by the text.

As illustrated in FIG. 1B, to generate an output audio signal 104, the audio generation system 100 implements a preprocessing engine 108, a generative neural network 112, and a postprocessing engine 116.

At a high level, the audio generation system 100 uses the generative neural network 112 to generate a sequence of output tokens 114 from a sequence of input tokens 110 over a plurality of iterations. As will be discussed in greater details below, in some implementations, the generative neural network 112 can be used to generate a sequence of output tokens 114 in exactly a fixed number of iterations no matter the length of the sequence of output tokens 114. This is faster as well as more computationally efficient than auto-regressively generating output tokens one after another.

Before the first iteration of the operations performed by the generative neural network 112, the preprocessing engine 108 generates the sequence of input tokens 110 that includes a respective input token at each of a plurality of positions in the sequence of input tokens 110.

The positions generally correspond to time steps spanning a specified time window of the output audio signal 104. In some implementations, the correspondence is a one-to-one correspondence, such that each position can correspond to a time step. In other implementations, the correspondence is a many-to-one correspondence, such that two or more positions can correspond to a time step. In either implementations, the positions can be partitioned into multiple frames (or segments), where the multiple frames can each include a fixed number of positions.

Throughout this specification, an “embedding” refers to an ordered collection of numerical values, e.g., a vector, matrix, or other tensor of numerical values (e.g., integers or floating point values). A “token” can represent an individual data element from a discrete (e.g., finite) set of data elements. For example, a token can represent one of a plurality of code vectors in a codebook for a quantizer, e.g., a codebook for a vector quantizer included in a residual (i.e., multi-stage) vector quantizer (RVQ). To that end, a token can similarly be in the form of an ordered collection of numerical values. For example, each token can include one or more numerical values.

Throughout this specification, a “residual vector quantizer” (RVQ) can refer to a multi-stage vector quantization technique that is based on a sequence of (residual) vector quantizers. A vector quantizer can quantize an input vector, e.g., by identifying a code vector from a codebook of code vectors associated with the vector quantizer, e.g., that has a smallest distance from the input vector, e.g., according to a distance metric (e.g., based on an L1 norm). The residual vector quantizer can quantize an input vector (or “signal”) by iteratively quantizing the residual errors from previous quantization stages. Thus each stage in a residual vector quantizer encodes the difference (or residual) between the original signal and the reconstructed signal from the previous stage, thereby progressively refining the approximation of the original signal with each step.

The sequence of input tokens 110 includes masked tokens. A “masked token” is a token that includes predetermined numerical values and that signifies that the corresponding token in the sequence of input tokens 110 has not been generated, e.g., selected from a predetermined set of tokens, yet.

The preprocessing engine 108 can generate a sequence of input tokens 110 that is the same length as the sequence of output tokens 114, i.e., the number of positions included in the sequence of input tokens 110 is identical to the number of positions included in the sequence of output tokens 114. The length of the sequence of output tokens 114 can be predetermined or specified by a user of the audio generation system 100.

In some implementations, the sequence of input tokens 110 is composed entirely of masked tokens, i.e., includes a masked token at each of the plurality of positions in the sequence of input tokens 110.

In some implementations, the sequence of input tokens 110 includes both masked tokens and conditioning tokens, e.g., includes a masked token at each of some of the plurality of positions in the sequence of input tokens 110, and includes a conditioning token at each of others of the plurality of positions in the sequence of input tokens 110. In other words, each position in the sequence of input tokens 110 is occupied by either a masked token or a conditioning token.

In some of these implementations, the sequence of input tokens 110 are arranged in a particular order. For example, the sequence of input tokens 110 include conditioning tokens followed by masked tokens. That is, the input tokens are masked after a particular time step (i.e., corresponding to the end of the context).

The sequence of input tokens 110 can include conditioning tokens when the audio generation system 100 receives a context, e.g., an input audio signal, text data, visual data, or some combination thereof, along with the request 102. In other words the conditioning tokens can be generated from the context.

In some of these implementations, the conditioning tokens include semantic tokens. When included, the semantic tokens define a semantic representation of the output audio signal. For example, the semantic token at a given position can represent semantic content of the output audio signal at the time step that corresponds to the given position. Each semantic token can be selected from a vocabulary of semantic tokens. Examples of semantic content that can be represented by the tokens include linguistic content for speech and melody and rhythm for music.

The semantic tokens can be generated in any of a variety of ways. In one example, they can be generated by an auxiliary audio processing neural network that is included in, or accessible by, the preprocessing engine 108. The auxiliary audio processing neural network can be a self-attention based model, e.g., a Transformer-based model or a Conformer-based model, e.g., a W2v-BERT neural network (described in Chung, Yu-An, et al. “W2v-bert: Combining contrastive learning and masked language modeling for self-supervised speech pre-training.” 2021 IEEE Automatic Speech Recognition and Understanding Workshop (ASRU)), for example. The preprocessing engine 108 can generate the semantic tokens based on outputs of one or more layers, e.g., of one of the intermediate layers, of the auxiliary audio processing neural network.

In some of these implementations, the conditioning tokens include acoustic tokens. When included, the acoustic tokens define an acoustic representation of the output audio signal. For example, the acoustic token at a given position can represent acoustic properties of the output audio signal at the time step that corresponds to the given position. Acoustic properties capture the details of an audio waveform and allow for high-quality synthesis. Acoustic properties can include, for example, speaker identity. Acoustic properties can also include recording conditions such as level of reverberation, distortion, and background noise.

The acoustic tokens can be generated in any of a variety of ways. In one example, the acoustic tokens can be generated by a neural audio codec that is included in, or accessible by, the preprocessing engine 108. Examples of a neural audio codec and operations performed by a neural audio codec are described in more details in Borsos, Zalán, et al. “Audiolm: a language modeling approach to audio generation.” IEEE/ACM Transactions on Audio, Speech, and Language Processing (2023), Kharitonov, Eugene, et al. “Speak, read and prompt: High-fidelity text-to-speech with minimal supervision.” Transactions of the Association for Computational Linguistics 11 (2023): 1703-1718, and Agostinelli, Andrea, et al. “Musiclm: Generating music from text.” arXiv preprint arXiv:2301.11325 (2023).

Such neural audio codecs can generate the acoustic tokens using one or more vector quantizers, e.g., a residual vector quantizer that includes a cascade of multiple vector quantizers, and conditioned on other conditioning tokens, e.g., embedding tokens generated from the context, e.g., from the input audio signal or text data, semantic tokens, or both.

In this example, the neural audio codec encodes the conditioning tokens using a hierarchy of multiple vector quantizers that each generate a respective acoustic token from a corresponding codebook of token vectors for the vector quantizer. The hierarchy includes one or more coarse vector quantizers at one or more first levels in the hierarchy and one or more fine vector quantizers at one or more last levels in the hierarchy. The set of acoustic tokens at positions within a given frame thus includes, for each vector quantizer, a respective acoustic token selected from the codebook for the vector quantizer.

For example, the hierarchy can include Q vector quantizers arranged in the order of 1 . . . Q′, (Q′+1) . . . Q, and the vector quantizers 1 . . . Q′ can be coarse vector quantizers, and the vector quantizers (Q′+1) . . . Q can be fine vector quantizers. The coarse vector quantizers generate coarse acoustic tokens, or acoustic tokens for coarse vector quantizers, that can represent acoustic properties such as speaker identity and recording conditions. The fine vector quantizers generate fine acoustic tokens, or acoustic tokens for fine vector quantizers, that can represent fine acoustic details. For example, fine acoustic tokens can be used to remove lossy compression artifacts in the coarse acoustic tokens.

In some of these implementations, the conditioning tokens include both acoustic tokens and semantic tokens. When the positions in the sequence of input tokens 110 are partitioned into multiple frames, the preprocessing engine 108 can generate the sequence of input tokens 110 in a time-aligned way, such that each frame includes the same number of acoustic tokens and semantic tokens, e.g., includes both an acoustic token and a semantic token.

In practice, because the acoustic tokens and semantic tokens may be generated at different sampling rates, the preprocessing engine 108 can convert, e.g., through resampling, the sampling rate of one of the tokens to the sampling rate of another of the tokens. Suppose, for example, the acoustic tokens have a higher sampling rate than the semantic tokens, then the preprocessing engine 108 can upsample the semantic tokens to match the higher sampling rate of the acoustic tokens when generating the conditioning tokens. In some implementations, the semantic tokens can be upsampled by duplicating tokens appropriately.

The audio generation system 100 then uses the generative neural network 112 to generate a sequence of output tokens 114 from the sequence of input tokens 110 over a plurality of iterations. Like the sequence of input tokens 110, the sequence of output tokens 114 includes a respective output token at each of the plurality of positions in the sequence of output tokens 114, but the tokens that reside at these positions do not include any masked tokens. That is, the audio generation system 100 generates the sequence of output tokens 114 by gradually unmasking all of the masked tokens that were originally included in the sequence of input tokens 110.

During each iteration, the audio generation system 100 performs a forward pass through the generative neural network 112, i.e., uses the generative neural network 112 to process a network input in accordance with its parameters, to generate an updated sequence of input tokens. For the first iteration, the network input includes the sequence of input tokens 110. For any subsequent iteration, the network input includes the updated sequence of input tokens that has been generated in the immediately preceding iteration.

Then, at each iteration, the audio generation system 100 uses the generative neural network 112 to process the network input to generate one or more new tokens to replace the respective masked tokens in the sequence of input tokens 110. That is, at each iteration, the generative neural network 112 is used to generate an updated sequence of input tokens that has fewer masked tokens.

After the last iteration, the audio generation system 100 uses the updated sequence of input tokens that has been generated in the last iteration as the sequence of output tokens 114, and uses the postprocessing engine 116 to generate an output audio signal 104 that satisfies the request 102 from the sequence of output tokens 114.

The audio generation system 100 then outputs the output audio signal 104. For example, the audio generation system 100 can provide the output audio signal 104 for presentation or play back to a user through a speaker or another audio output device, or store the output audio signal 104 for later use.

To generate the output audio signal 104, the postprocessing engine 116 implements or accesses software that can convert the tokens into an audio waveform indicative of the audio signal, e.g., a time-domain audio waveform that defines an amplitude of the audio signal over time. For example, the software can include the detokenizer mentioned in Borsos, Z., Marinier, et al. Audiolm: a language modeling approach to audio generation. arXiv:2209.03143, 2022.

The sequence of output tokens 114 are therefore decodable into an audio signal. In some implementations, the output tokens correspond to a compressed encoding of an audio signal. The output tokens can be decoded/decompressed as appropriate to generate the output audio signal 104. In implementations where the tokens represent code vectors from a codebook for a residual vector quantizer (RVQ), for each frame in the sequence of output tokens 114, the postprocessing engine 116 can combine, e.g., concatenate or sum, the code vectors represented by the tokens within the frame and then process at least the combined code vectors using a decoder neural network to generate a prediction of the output audio signal 104. For example, the decoder neural network can be the SoundStream decoder neural network mentioned in Zeghidour, Neil, et al. “Soundstream: An end-to-end neural audio codec.” IEEE/ACM Transactions on Audio, Speech, and Language Processing 30 (2021): 495-507.

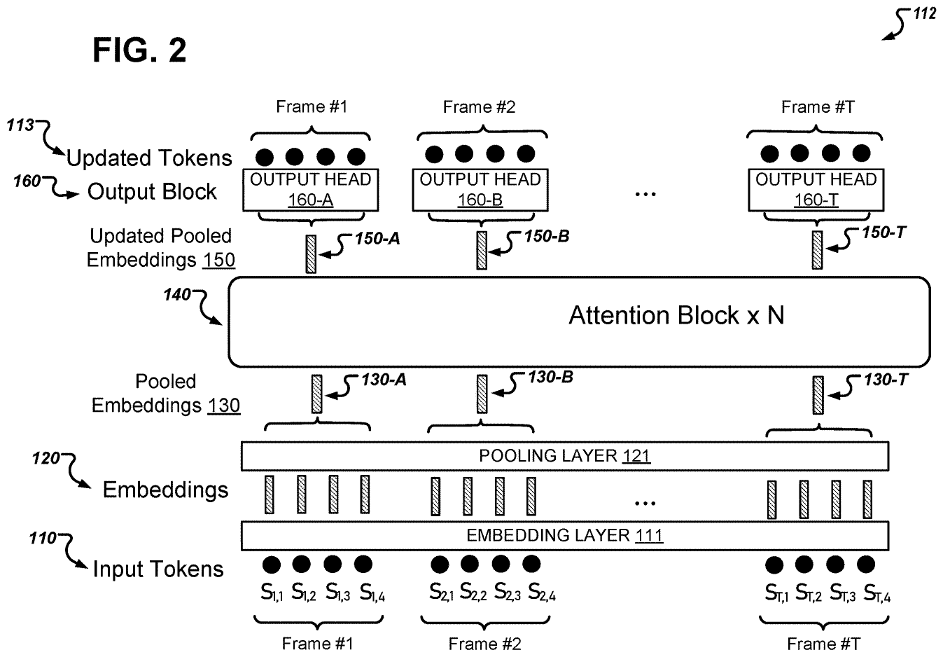

FIG. 2 is an example illustration of operations performed by the generative neural network 112 at a given iteration. The generative neural network 112 includes an embedding layer 111, followed by a pooling layer 121, followed by one or more attention blocks 140, followed by an output block 160.

The generative neural network 112 receives a network input for the given iteration. When the given iteration is the first iteration, the network input includes the sequence of input tokens 110. When the given iteration is a subsequent iteration, the network input includes the updated sequence of input tokens that has been generated in the immediately preceding iteration.

The embedding layer 111 processes the network input to generate a sequence of embeddings 120. The sequence of embeddings includes a respective embedding of each token in the sequence of input tokens 110 (or the updated sequence of input tokens).

The pooling layer 121 processes the sequence of embeddings 120 to generate a sequence of pooled embeddings 130. The pooling layer 121 generates each pooled embedding in the sequence of pooled embeddings 130 by applying a pooling operation over a respective plurality of embeddings from the sequence of embeddings. For example, to generate the pooled embedding 130-A in FIG. 2, the pooling layer 121 can apply a pooling operation over the embeddings of the tokens that occupy the positions within the first frame in the sequence of input tokens 110. The first frame can include a first number of positions (four, in the example of FIG. 2) in the sequence of input tokens 110.

The pooling operation can be, for example, an average pooling operation, minimum pooling operation, or maximum pooling operation. The pooling layer 121 can apply the pooling operation in accordance with a predetermined stride value. For example, the stride value can be dependent on a total number of the vector quantizers included in the SoundStream neural audio codec that has been used to generate the acoustic tokens included in the sequence of input tokens 110, e.g., the stride value can be the same as the total number of the vector quantizers.

Each attention block 140 includes one or more convolutional layers and one or more attention layers. Each attention block 140 may thus be also referred to as a “convolution-augmented attention block.” Convolution-augmented attention block is described in more detail in Anmol Gulati, et al. Conformer: Convolution-augmented transformer for speech recognition. In Interspeech 2020, 21st Annual Conference of the International Speech Communication Association, Shanghai, China, 25-29 Oct. 2020, pages 5036-5040. ISCA, 2020, the content of which is incorporated by reference herein in its entirety.

Each attention block 140 processes the sequence of pooled embeddings, or data derived from the sequence of pooled embeddings, to update the sequence of pooled embeddings by applying both convolution operations and attention operations to generate an updated sequence of pooled embeddings 150.

In the case of multiple attention blocks, they can be stacked, i.e., arranged in a sequence with the output of any attention block except the last being an input to another of the attention blocks, such that the multiple attention blocks sequentially apply a plurality of convolution operations and attention operations to the sequence of pooled embeddings, and that the updated sequence of pooled embeddings is the output of the last attention block.

In some implementations, the one or more attention layers within an attention block 140 are self-attention attention layers that are each configured to apply self-attention operations. In some of these implementations, the self-attention attention layers are local self-attention layers that are each configured to apply local self-attention operations. Local self-attention is a self-attention mechanism that considers only a subset of all the positions included in the sequence of input tokens 110.

The output block 160, in turn, includes a plurality of output heads 160-A-160-T. The plurality of output heads 160-A-160-T generally correspond to the frames in the sequence of input tokens 110. In some implementations, the number of output heads is the same of the number of the frames in the sequence of input tokens 110. In the example of FIG. 2, the generative neural network 112 thus includes a total of T output heads that correspond respectively to the T frames in the sequence of input tokens 110. T can be any natural number.

Each output head can have an identical architecture. In some implementations, each output head includes one or more layers, e.g., one or more dense layers. Each output head processes at least a portion of the updated sequence of pooled embeddings to generate, for each of one or more positions in the sequence of input tokens 110, a respective prediction characterizing a new, unmasked token that should occupy the position in the sequence of input tokens 110.

In particular, each output head is configured to operate independently and in parallel with other output heads included in the output block 160. That is, each output head processes at least a portion of the sequence of updated pooled embeddings to generate the respective predictions characterizing the unmasked tokens that should occupy some of the positions in the sequence of input tokens 110 in parallel with other each other output head that processes at least a portion of the sequence of updated pooled embeddings to generate the respective predictions characterizing the unmasked tokens that should occupy some others of the positions in the sequence of input tokens 110.

For example, in FIG. 2, output head 160-A receives an updated pooled embedding 150-A, which corresponds to the first frame in the sequence of input tokens 110, and processes the updated pooled embedding 150-A to generate a respective prediction characterizing each of the tokens that occupy at least some of the positions, e.g., the positions occupied by masked tokens, within the first frame in the sequence of input tokens 110.

The prediction characterizing an unmasked token can be generated stochastically, e.g., where the output of the output head parameterizes, for any given position, a score distribution over a predetermined set of tokens from which a token can be determined, and the determined token will then be used as the unmasked token that should occupy the given position. For example, the predetermined set of tokens can include the tokens that can represent a plurality of code vectors in a codebook for a quantizer, e.g., a codebook for a residual vector quantizer. For example, a token can be determined by greedily selecting the highest-scoring token or through sampling, e.g., using nucleus sampling or another sampling technique, from the score distribution.

The updated sequence of input tokens 113 for the given iteration can then be generated by replacing the masked tokens at some of the positions in the sequence of input tokens 110 with the unmasked tokens, i.e., by including the unmasked tokens in place of the masked tokens in the sequence of input tokens 110. Thus, at the end of the given iteration, the generative neural network 112 can generate an updated sequence of input tokens-or, put another way, a partially masked representation of the audio signal that has fewer masked tokens.

Moreover, this architecture of the generative neural network 112 gives it the flexibility to be configured either as an encoder for representation learning, or as a decoder for audio generation. That is, the generative neural network 112 can either be trained for self-supervised audio representation learning via masked audio modeling, or non-autoregressive audio generation via parallel, confidence-based decoding. Training the generative neural network 112 will be described further below.

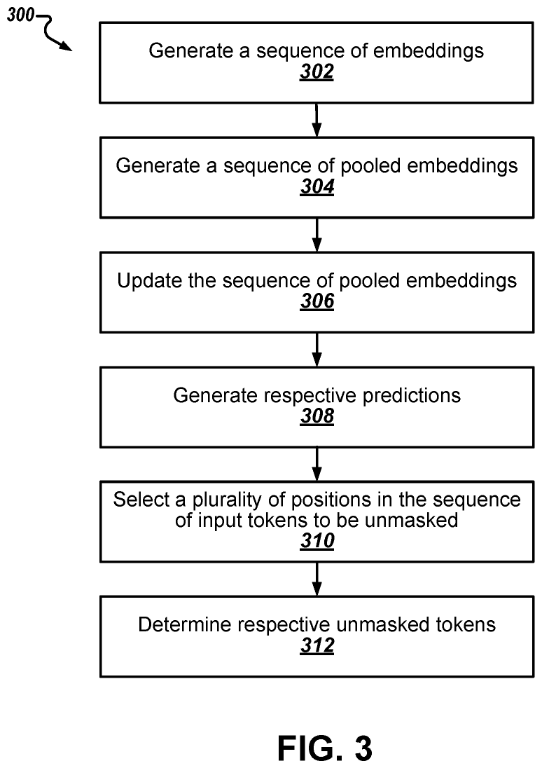

FIG. 3 is a flow diagram of an example process 300 for processing a masked representation of an audio signal using a neural network. For convenience, the process 300 will be described as being performed by a system of one or more computers located in one or more locations. For example, an audio generation system, e.g., the audio generation system 100 depicted in FIG. 1, appropriately programmed in accordance with this specification, can perform the process 300.

In some implementations, the audio generation system is implemented on a local, user device, e.g., a smartphone, tablet, or personal computer, and the steps of the process 300 are performed partly or wholly on the local, user device. In some implementations, some components of the audio generation system are implemented on a local device while other components of the audio generation system are implemented in a data center, and some of the steps of the process 300 are performed on the local device and other steps of the process 300 are performed in the data center. In some implementations, the audio generation system is implemented in a data center that is communicatively coupled to a client device. After the steps of the process 300 are performed partly or wholly in the data center, the data center then transmits the output audio signal to the client device.

The audio generation system includes a generative neural network. The generative neural network includes an embedding layer, followed by a pooling layer, followed by one or more attention blocks, followed by an output block.

Prior to the first iteration of the process 300, the system obtains a masked representation of an audio signal as a sequence of input tokens. The sequence of input tokens includes a respective input token at each of a plurality of positions in the sequence of input tokens. The sequence of input tokens includes masked tokens. That is, at least some of the positions in the sequence of input tokens are occupied by masked tokens.

The system can repeatedly perform multiple iterations of process 300 to iteratively update the sequence of input tokens, and use the updated sequence of input tokens that is generated in the last iteration of the process 300 as a sequence of output tokens. By repeatedly performing iterations of process 300, the system can generate a sequence of output tokens that includes a respective output token at each of the plurality of positions in the sequence of input tokens, and that is an unmasked representation of the audio signal.

At the beginning of a given iteration of the process 300, the generative neural network receives a network input for the given iteration. When the given iteration is the first iteration, the network input includes the sequence of input tokens. When the given iteration is a subsequent iteration, the network input includes the updated sequence of input tokens that has been generated in the immediately preceding iteration.

The system processes the network input using an embedding layer of the generative neural network to generate a sequence of embeddings (step 302). The sequence of embeddings includes a respective embedding of each token in the sequence of input tokens (or the updated sequence of input tokens).

The system processes the sequence of embeddings using a pooling layer of the generative neural network to generate a sequence of pooled embeddings (step 304). Each pooled embedding in the sequence of pooled embeddings results from pooling a respective subset of embeddings from the sequence of embeddings.

The system processes the sequence of pooled embeddings using one or more attention blocks of the generative neural network to update the sequence of pooled embeddings (step 306). Each attention block includes one or more convolutional layers and one or more attention layers. Each attention block processes the sequence of pooled embeddings, or data derived from the sequence of pooled embeddings, to update the sequence of pooled embeddings by applying both convolution operations and attention operations.

The system processes at least a portion of the updated sequence of pooled embeddings using the output block of the generative neural network to generate, for each of one or more positions in the sequence of input tokens, a respective prediction characterizing a token that should occupy the position in the sequence of input tokens (step 308).

The output block includes a plurality of output heads that operate independently and in parallel with other output heads. Each output head can correspond to a frame in the sequence of input tokens. Each frame can include a respective subset of the positions in the sequence of input tokens.

That is, each output head processes at least a portion of the sequence of updated pooled embeddings to generate the respective predictions characterizing the unmasked tokens that should occupy some of the positions in the sequence of input tokens in parallel with other each other output head that processes at least a portion of the sequence of updated pooled embeddings to generate the respective predictions characterizing the unmasked tokens that should occupy some others of the positions in the sequence of input tokens.

The system selects a plurality of positions in the sequence of input tokens to be unmasked (step 310). Each position selected to be unmasked is occupied by a masked token.

In particular, the system can start by identifying a subset of the sequence of input tokens that are eligible to be unmasked at the current iteration. For instance, as described above, each token in the sequence of input tokens can be associated with a respective vector quantizer at a particular level/position in a sequence of vector quantizers. The system can be configured to unmask the tokens in the input sequence level by level, starting from the first level in the sequence of vector quantizers. Thus, the system can identify the subset of the sequence of input tokens that are eligible for unmasking at the current iteration as any masked token in the input sequence of tokens that is associated with level that is being unmasked at the current iteration.

After identifying the subset of the sequence of input tokens that are eligible to be unmasked at the current iteration, the system can identify some or all of the tokens set of eligible tokens for unmasking at the current iteration.

In some cases, the system can select all the tokens that are eligible to be unmasked at the current iteration as tokens that should be unmasked at the current iteration.

In other cases, the system can select more than one but fewer than all of the tokens that are eligible to be unmasked at the current iteration as tokens that should be unmasked at the current iteration. For instance, for each token that is eligible to be unmasked at the current iteration, the system can use the generative neural network to generate a score distribution over a set of possible tokens that can be selected to occupy the position currently occupied by the masked token. The system can identify a plurality of tokens associated with the highest confidence scores from among the tokens that are eligible to be unmasked at the current iteration as the tokens that should be unmasked at the current iteration. The “confidence score” for a masked token that is eligible to be unmasked can be based on the score distribution generated by the generative neural network for the masked token. For instance, the confidence score can be the highest score assigned to a token by the score distribution, or the confidence score can be based on, e.g., a measure of dispersion of the confidence score distribution, e.g., an inverse of a measure of dispersion of the confidence score distribution.

The generative neural network can generate tokens that be decoded into an audio signal. The tokens can correspond to an encoded/compressed representation of an audio signal. In more detail, the generative neural network can generate tokens that represent code vectors that could be generated by a hierarchy of multiple vector quantizers which will be further processed by a decoder neural network to generate the output audio, as mentioned earlier, this selection can be made based on a predetermined order in which the multiple vector quantizers are arranged.

Specifically, when different positions in the sequence of input tokens are associated with different vector quantizers in a sequence of vector quantizers 1 . . . Q′, (Q′+1) . . . Q included in a neural audio codec (e.g., the neural audio codec that is configured to generate the acoustic tokens, as mentioned above) that are arranged in a hierarchical order, then for each position in the sequence of input tokens that is occupied by a masked token, the system can determine whether to select the position to be unmasked based on the residual vector quantizer associated with the position.

For example, the hierarchical order can be a coarse-to-fine order. That is, the hierarchy can include one or more coarse vector quantizers at one or more first levels in the hierarchy and one or more fine vector quantizers at one or more last levels in the hierarchy.

In this example, the system can proceed to select, from among the plurality of positions in the sequence of input tokens, additional positions associated with a fine vector quantizer Q′+1 to be unmasked only after the positions within the plurality of positions in the sequence of input tokens that are associated with a coarse vector quantizer Q′ have all been unmasked.

Further, some implementations of the system can adopt a predetermined schedule that specifies a respective number of iterations for each vector quantizer in the hierarchy. Suppose, for example, there is a total of 12 vector quantizers in the hierarchy, the predetermined schedule can specify (16; 1; 1; ::: ; 1) iterations for the vector quantizers. That is, the system performs 16 iterations to unmask the tokens residing at positions associated with the first (coarse) level and then performs one iteration to unmask the tokens residing at positions associated with each subsequent level, in the coarse-to-fine order. This predetermined schedule thus results in a total of 27 forward passes with the generative neural network.

The system determines, for each of the plurality of tokens selected to be unmasked, a respective unmasked token to occupy the position currently occupied by the masked token based on a prediction generated by the generative neural network for the token that should occupy the position (step 312). The positions that have not been selected in the iteration remain occupied by masked tokens, and can be re-predicted by the generative neural network in the next iteration.

In some implementations, the prediction generated by the generative neural network for the token that should occupy the position includes a score distribution over a predetermined set of tokens, i.e., includes a score for each token in the predetermined set of tokens. Then, for each of the plurality of positions selected to be unmasked, the unmasked token to occupy the position can be determined by greedily selecting the highest-scoring token or through sampling, e.g., using nucleus sampling or another sampling technique, from the score distribution.

The updated sequence of input tokens for the iteration can then be generated by replacing the masked tokens at some of the positions in the sequence of input tokens with the sampled tokens, i.e., by including the unmasked tokens in place of the masked tokens in the sequence of input tokens.

The process 300 can be performed as part of predicting a sequence of output tokens from a sequence of input tokens for which the desired sequence of output tokens, i.e., the output tokens that should be generated by the system for the sequence of input tokens, are not known.

The process 300 can also be performed as part of processing inputs tokens derived from a training dataset, i.e., inputs derived from a set of inputs for which the output tokens that should be generated by the system is known, in order to train the generative neural network to determine trained values for the parameters of the generative neural network.

The system (or another training system) can train the generative neural network on such a training dataset through self-supervised audio representation learning. Specifically, the system can repeatedly perform the process 300 on training examples selected from the training dataset to train the generative neural network, e.g., a gradient descent with backpropagation training technique that uses a conventional optimizer, e.g., stochastic gradient descent, RMSprop, or Adam optimizer, on an audio representation learning task based on optimizing an appropriate objective function for the task.

In one example, the audio representation learning task can be a masked audio modeling task. For each training example selected from the training dataset, the masked audio modeling task is a task that requires predicting, given a sequence of input tokens that include masked tokens, a sequence of output tokens that include unmasked tokens in place of the masked tokens and that represent an audio signal.

During training, the system can generate a sequence of input tokens that is a masked representation of an audio signal by generating a sequence of tokens from a training example selected from the training dataset, where each training examples represents an audio signal, and then replacing some of the tokens with masked tokens. The sequence of input tokens can include at least a predetermined number of masked tokens, e.g., about 20%, 30%, 40%, or the like, of the input tokens included in the sequence are masked tokens.

For example, the system can do this by determining a start time step within a plurality of time steps of the audio signal, and then replacing tokens at a predetermined number of contiguous time steps, e.g., 100 ms, 200 ms, 300 ms, or the like, that follow the start time step with masked tokens.

As another example, the system can obtain a sequence of tokens representing an audio signal that has been generated by a sequence of residual vector quantizers in a neural audio codec. The system can then select a target vector quantizer from the sequence of vector quantizers, and mask only tokens that are associated with the target vector quantizer or vector quantizer that are after the target vector quantizer in the sequence of vector quantizers.

In one example, the system can adopt the following masking scheme to generate a sequence of input tokens from a training example selected from the training dataset:
Sample the context delimiter timestep t~U{0, T−1};
Sample the current residual vector quantizer (RVQ) level q~U{1, Q};
Sample the mask M∈{0, 1}^{T} according to a cosine schedule for level q, i.e., sample the masking ratio p=cos(u) where u~U[0, π/2], and sample iid Mi~Bernoulli(p).
Mask the selected non-conditioning tokens at the current RVQ level q (mask Y_{t′,q} if M_{t′}=1 and t′>t) and all non-conditioning tokens at finer RVQ levels (Y_{>t;>q}), where t∈{1, . . . , T}, where T denotes the maximum sequence length, and any tokens before timestep t will not be masked. The conditioning tokens are also not masked. Y∈{1, . . . , C}^{T×Q} represent the acoustic tokens, where C is the codebook size used in each RVQ level out of the Q levels.

Generally, the objective function can be any function that evaluates a loss of the prediction outputs generated by the generative neural network with respect to the masked positions. That is, the objective function can include a first term that evaluates, for each of one or more positions in the sequence of tokens that are occupied by masked tokens, a first difference between: (i) the token that should occupy the position, and (ii) the respective prediction characterizing the token that should occupy the position generated by the generative neural network. For example, the first difference can be evaluated as a cross-entropy loss.

In some cases, the loss is evaluated with respect to a subset of all positions in the sequence of tokens. For example, when different positions in the sequence of tokens are associated with different vector quantizers in a sequence of vector quantizers 1 . . . Q′, (Q′+1) . . . Q included in a neural audio codec, the loss can be evaluated with respect to only the positions in the sequence of tokens that are associated with one of the Q vector quantizers.

In some cases, the objective function can also evaluate a loss of the prediction outputs generated by the generative neural network with respect to the unmasked positions. That is, the objective function objective function can also include a second term that evaluates, for each of one or more positions in the sequence of tokens that are occupied by unmasked tokens, a second difference between: (i) the token that should occupy the position, and (ii) the respective prediction characterizing the token that should occupy the position. Analogously, the second difference can be evaluated as a cross-entropy loss. In implementations such a loss with respect to the unmasked positions may result in faster convergence and improved performance of the neural network in a variety of downstream tasks.

In some of these cases, the objective function can assign different weights to the first term and the second term. For example, the objective function can down-weight the second term relative to the first term, e.g., can use loss weights of 10 and 1, 20 and 1, or 50 and 1 for masked versus unmasked positions, respectively.

In this example, the system can then determine, based on computing the gradients of the objective function that includes the first difference and, in some cases, the second difference, with respect to the parameters of the generative neural network, one or more updates to the values of the parameters of the generative neural network.

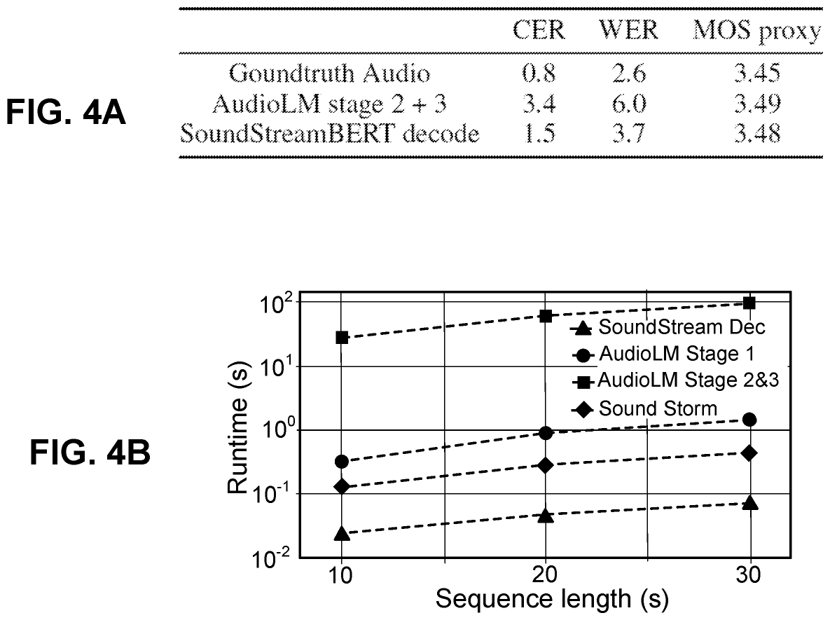

FIGS. 4A-B show quantitative examples of the performance gains that can be achieved by audio generation system described in this specification.

FIG. 4A shows a comparison between the qualities of audio signals generated by a SoundStreamBERT system (corresponding to the audio generation system described in this specification) and an AudioLM system (described in Zalán Borsos, et al. AudioLM: a language modeling approach to audio generation. arXiv preprint arXiv:2209.03143, 2022).

It will be appreciated that the SoundStreamBERT system achieves lower character error rate (CER) and lower word error rate (WER) than the AudioLM system.

Furthermore, the quality of the audio signal generated by the SoundStreamBERT system more closely matches the quality of the ground truth audio signal in terms of a MOS proxy measure. The MOS proxy measure is an estimate the perceived quality of the generated audio signals that can be determined using a MOS estimator similar to the DNSMOS estimator (described in Reddy, C. K. A., et al. DNSMOS: A non-intrusive perceptual objective speech quality metric to evaluate noise suppressors. In IEEE International Conference on Acoustics, Speech and Signal Processing (DNSMOS), 2021). FIG. 4B shows a comparison between the runtime of the different systems to generate 10 seconds, 20 seconds, and up to 30 seconds of audio signal when executed on the same hardware device (a TPUv4 chip). FIG. 4B shows that the SoundStorm system can generate audio signal two orders of magnitude faster than AudioLM system (“AudioLM Stage 2&3”), with a real time factor of 0.017, including decoding to waveform by the SoundStream decoder (“SoundStream Dec”).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following numbered clauses:

Clause 1. A method performed by one or more computers, the method comprising:
receiving a masked representation of an audio signal as a sequence of tokens, wherein the sequence of tokens comprises one or more masked tokens;
processing the masked representation of the audio signal using a neural network, comprising:
   processing the masked representation of the audio signal using an embedding layer of the neural network to generate a sequence of embeddings that comprises a respective embedding of each token in the sequence of tokens;
   processing the sequence of embeddings using a pooling layer of the neural network to generate a sequence of pooled embeddings, wherein each pooled embedding in the sequence of pooled embeddings results from pooling a respective plurality of embeddings from the sequence of embeddings;
   processing the sequence of pooled embeddings using an attention block of the neural network to update the sequence of pooled embeddings, comprising applying one or more self-attention operations to the sequence of pooled embeddings; and
   processing the updated sequence of pooled embeddings to generate, for each of one or more positions in the sequence of tokens, a respective prediction characterizing a token that should occupy the position in the sequence of tokens.

Clause 2. The method of clause 1, wherein the attention block is a convolution-augmented attention block that comprises one or more convolutional layers and one or more self-attention layers.

Clause 3. The method of any preceding clause, wherein applying one or more self-attention operations to the sequence of pooled embeddings comprises:
applying one or more local self-attention operations to the sequence of pooled embeddings.

Clause 4. The method of clause 3, wherein applying one or more local self-attention operations to the sequence of pooled embeddings comprises:
sequentially applying a plurality of local self-attention operations to the sequence of pooled embeddings.

Clause 5. The method of any preceding clause, wherein receiving the representation of the audio signal as a sequence of tokens comprises:
receiving a sequence of acoustic tokens generated by a neural audio codec comprising a plurality of residual vector quantization layers.

Clause 6. The method of clause 5, wherein receiving the representation of the audio signal as a sequence of tokens comprises:
receiving a sequence of semantic tokens generated by an intermediate layer of an auxiliary audio processing neural network.

Clause 7. The method of clause 6, wherein receiving the sequence of semantic tokens comprises resampling the sequence of semantic tokens based on a sampling rate of the sequence of acoustic tokens.

Clause 8. The method of any one of clauses 5-7, wherein processing the sequence of embeddings using the pooling layer to generate the sequence of pooled embeddings comprises:
processing, by the pooling layer, the sequence of embeddings in accordance with a stride that is dependent on a total number of the residual vector quantization layers.

Clause 9. The method of clause 8, wherein a value of the stride is the same as the total number of the residual vector quantization layers.

Clause 10. The method of any one of clauses 1-9, wherein the output block comprises multiple output heads and wherein processing the updated sequence of pooled embeddings to generate, for each of one or more positions in the sequence of tokens, a respective prediction characterizing the token that should occupy the position in the sequence of tokens comprises:
processing the sequence of updated pooled embeddings by each output head independently and in parallel with other output heads to generate respective predictions characterizing a plurality of tokens at different positions in the sequence of tokens.

Clause 11. The method of clause 10, wherein each output head is configured to:
receive a respective pooled embedding from the updated sequence of pooled embeddings;
processing the pooled embedding to generate a respective prediction for each position in a same frame of the sequence of tokens, wherein the output head generates the predictions for positions in the same frame in parallel.

Clause 12. The method of any preceding clause, further comprising:
selecting a plurality of positions in the sequence of tokens to be unmasked, wherein each position selected to be unmasked is occupied by a masked token; and
determining, for each of the plurality of positions selected to be unmasked, a respective unmasked token to occupy the position based on a prediction generated by the neural network for the token that should occupy the position.

Clause 13. The method of clause 12, wherein selecting a plurality of positions in the sequence of tokens to be unmasked comprises, for each position in the sequence of tokens that is occupied by a masked token:
determining whether to select the position to be unmasked based on a confidence in a prediction generated by the neural network characterizing the token that should occupy the position in the sequence of tokens.

Clause 14. The method of any one of clauses 12-13, wherein some or all of the positions in the sequence of tokens are associated with a respective residual vector quantization layer in a sequence of residual vector quantization layers; and
wherein selecting a plurality of positions in the sequence of tokens to be unmasked comprises, for each position in the sequence of tokens that is occupied by a masked token:
determining whether to select the position to be unmasked based on the residual vector quantization layer associated with the position.

Clause 15. The method of any one of clauses 12-14, wherein for each of the plurality of positions selected to be unmasked, the prediction generated by the neural network for the token that should occupy the position comprises a score distribution over a set of tokens.

Clause 16. The method of clause 15, wherein for each of the plurality of positions selected to be unmasked, determining the unmasked token to occupy the position comprises:
sampling a token from the score distribution over the set of tokens.

Clause 17. The method of any preceding clause, further comprising:
determining, for each of one or more positions in the sequence of tokens that are occupied by masked tokens, a first difference between: (i) the token that should occupy the position, and (ii) the respective prediction characterizing the token that should occupy the position; and
determining, based at least on first difference, an update to values of a set of parameters of the neural network.

Clause 18. The method of clause 17, further comprising:
determining, for each of one or more positions in the sequence of tokens that are occupied by unmasked tokens, a second difference between: (i) the token that should occupy the position, and (ii) the respective prediction characterizing the token that should occupy the position; and
determining, based on both the first and second differences, the update to values of the set of parameters of the neural network.

Clause 19. The method of clause 18, wherein determining second difference comprises down-weighting the second difference relative to the first difference.

Clause 20. The method of any preceding clause, further comprising generating the masked representation of the audio signal as the sequence of tokens, comprising:
determining a start time step within a plurality of time steps of the audio signal; and
replacing tokens at a predetermined number of contiguous time steps that follow the start time step with masked tokens.

Clause 21. The method of any one of clauses 1-19, further comprising generating the masked representation of the audio signal as the sequence of tokens, comprising:
obtaining a representation of the audio signal as a sequence of tokens generated by a sequence of residual vector quantization layers in a neural audio codec;
selecting a target vector quantization layer;
masking only tokens that are associated with the target vector quantization layer or vector quantization layers that are after the target vector quantization layer in the sequence of vector quantization layers.

Clause 22. The method of any one of clauses 1-22, further comprising generating an output audio signal based at least on the respective unmasked tokens.

Clause 23. One or more computer storage media storing instructions that when executed by one or more computer cause the one or more computer to implement the neural network of any one of clauses 1-22.

Clause 24. A system comprising:
one or more computers; and
one or more storage devices storing instructions that, when executed by the one or more computers, cause the one or more computers to perform the respective operations of any one of clauses 1-22.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a masked representation of an audio signal as a sequence of tokens, wherein the sequence of tokens comprises one or more masked tokens;
processing the masked representation of the audio signal using a neural network, comprising:
processing the masked representation of the audio signal using an embedding layer of the neural network to generate a sequence of embeddings that comprises a respective embedding of each token in the sequence of tokens;
processing the sequence of embeddings using a pooling layer of the neural network to generate a sequence of pooled embeddings, wherein each pooled embedding in the sequence of pooled embeddings results from pooling a respective plurality of embeddings from the sequence of embeddings;
processing the sequence of pooled embeddings using an attention block of the neural network to update the sequence of pooled embeddings, comprising applying one or more self-attention operations to the sequence of pooled embeddings; and
processing the updated sequence of pooled embeddings to generate, for each of one or more positions in the sequence of tokens, a respective prediction characterizing a token that should occupy the position in the sequence of tokens.

2. The method of claim 1, wherein the attention block is a convolution-augmented attention block that comprises one or more convolutional layers and one or more self-attention layers.

3. The method of claim 1, wherein applying one or more self-attention operations to the sequence of pooled embeddings comprises:
applying one or more local self-attention operations to the sequence of pooled embeddings.

4. The method of claim 3, wherein applying one or more local self-attention operations to the sequence of pooled embeddings comprises:
sequentially applying a plurality of local self-attention operations to the sequence of pooled embeddings.

5. The method of claim 1, wherein receiving the representation of the audio signal as a sequence of tokens comprises:
receiving a sequence of acoustic tokens generated by a neural audio codec comprising a plurality of residual vector quantizers.

6. The method of claim 5, wherein receiving the representation of the audio signal as a sequence of tokens comprises:
receiving a sequence of semantic tokens generated by an intermediate layer of an auxiliary audio processing neural network.

7. The method of claim 6, wherein receiving the sequence of semantic tokens comprises resampling the sequence of semantic tokens based on a sampling rate of the sequence of acoustic tokens.

8. The method of claim 5, wherein processing the sequence of embeddings using the pooling layer to generate the sequence of pooled embeddings comprises:
processing, by the pooling layer, the sequence of embeddings in accordance with a stride that is dependent on a total number of the residual vector quantizers.

9. The method of claim 8, wherein a value of the stride is the same as the total number of the residual vector quantizers.

10. The method of claim 1, wherein an output block of the neural network comprises multiple output heads and wherein processing the updated sequence of pooled embeddings to generate, for each of one or more positions in the sequence of tokens, a respective prediction characterizing the token that should occupy the position in the sequence of tokens comprises:
processing the sequence of updated pooled embeddings by each output head independently and in parallel with other output heads to generate respective predictions characterizing a plurality of tokens at different positions in the sequence of tokens.

11. The method of claim 10, wherein each output head is configured to:
receive a respective pooled embedding from the updated sequence of pooled embeddings; and
process the pooled embedding to generate a respective prediction for each position in a same frame of the sequence of tokens, wherein the output head generates the predictions for positions in the same frame in parallel.

12. The method of claim 1, further comprising:
selecting a plurality of positions in the sequence of tokens to be unmasked, wherein each position selected to be unmasked is occupied by a masked token; and
determining, for each of the plurality of positions selected to be unmasked, a respective unmasked token to occupy the position based on a prediction generated by the neural network for the token that should occupy the position.

13. The method of claim 12, wherein selecting a plurality of positions in the sequence of tokens to be unmasked comprises, for each position in the sequence of tokens that is occupied by a masked token:
determining whether to select the position to be unmasked based on a confidence in a prediction generated by the neural network characterizing the token that should occupy the position in the sequence of tokens.

14. The method of claim 12, wherein some or all of the positions in the sequence of tokens are associated with a respective residual vector quantizer in a sequence of residual vector quantizers; and
wherein selecting a plurality of positions in the sequence of tokens to be unmasked comprises, for each position in the sequence of tokens that is occupied by a masked token:
determining whether to select the position to be unmasked based on the residual vector quantizer associated with the position.

15. The method of claim 14, wherein selecting the plurality of positions in the sequence of tokens to be unmasked comprises:
identifying a set of masked tokens that are eligible to be unmasked, comprising selecting each masked token that is associated with a particular residual vector quantizer for inclusion in the set of masked tokens that are eligible to be unmasked; and
selecting a plurality of tokens from the set of masked tokens that are eligible to be unmasked as tokens that should be simultaneously unmasked.

16. The method of claim 15, wherein all tokens associated with any residual vector quantizer that precedes the particular residual vector quantizer in the sequence of residual vector quantizers have already been unmasked; and
all tokens associated with any residual vector quantizer that is after the particular residual vector quantizer in the sequence of residual vector quantizers has not yet been unmasked.

17. The method of claim 12, wherein for each of the plurality of positions selected to be unmasked, the prediction generated by the neural network for the token that should occupy the position comprises a score distribution over a set of tokens.

18. The method of claim 17, wherein for each of the plurality of positions selected to be unmasked, determining the unmasked token to occupy the position comprises:
sampling a token from the score distribution over the set of tokens.

19-24. (canceled)

25. One or more computer storage media storing instructions that when executed by one or more computers cause the one or more computer to perform operations comprising:
receiving a masked representation of an audio signal as a sequence of tokens, wherein the sequence of tokens comprises one or more masked tokens;
processing the masked representation of the audio signal using a neural network, comprising:
processing the masked representation of the audio signal using an embedding layer of the neural network to generate a sequence of embeddings that comprises a respective embedding of each token in the sequence of tokens;
processing the sequence of embeddings using a pooling layer of the neural network to generate a sequence of pooled embeddings, wherein each pooled embedding in the sequence of pooled embeddings results from pooling a respective plurality of embeddings from the sequence of embeddings;
processing the sequence of pooled embeddings using an attention block of the neural network to update the sequence of pooled embeddings, comprising applying one or more self-attention operations to the sequence of pooled embeddings; and
processing the updated sequence of pooled embeddings to generate, for each of one or more positions in the sequence of tokens, a respective prediction characterizing a token that should occupy the position in the sequence of tokens.

26. A system comprising:
one or more computers; and
one or more storage devices storing instructions that, when executed by the one or more computers, cause the one or more computers to perform operations comprising:
receiving a masked representation of an audio signal as a sequence of tokens, wherein the sequence of tokens comprises one or more masked tokens;
processing the masked representation of the audio signal using a neural network, comprising:
processing the masked representation of the audio signal using an embedding layer of the neural network to generate a sequence of embeddings that comprises a respective embedding of each token in the sequence of tokens;
processing the sequence of embeddings using a pooling layer of the neural network to generate a sequence of pooled embeddings, wherein each pooled embedding in the sequence of pooled embeddings results from pooling a respective plurality of embeddings from the sequence of embeddings;
processing the sequence of pooled embeddings using an attention block of the neural network to update the sequence of pooled embeddings, comprising applying one or more self-attention operations to the sequence of pooled embeddings; and
processing the updated sequence of pooled embeddings to generate, for each of one or more positions in the sequence of tokens, a respective prediction characterizing a token that should occupy the position in the sequence of tokens.
